(19) United States
(12) Patent Application Publication
(10) Pub. No.: US 2005/0026113 A1
(43) Pub. Date: Feb. 3, 2005

(54) Micro-implantable apparatus and method for the stability assessment of a two-stage dental implant

(76) Inventors: Jiunn-Liang Chen, Taipei City (TW); Sheng-Yang Lee, Taipei City (TW); Hao-Ming Huang, Taipei City (TW); Kuang-Yu Cheng, Sindian City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/629,574

(22) Filed: Jul. 30, 2003

(51) Int. Cl. A61C 8/00

(52) U.S. Cl. 433/173

(57) ABSTRACT

A micro-implantable apparatus and method for the stability assessment of a two-stage dental implant during Osseo integration processes, whose detection device is based on a transmission of a pulse wave signal from an upper opening of an implant and a subsequent analysis of the reflection waves that measure the changes in mechanical interlock between the bone and the implant resulted from the wound healing processes happened at the gap between bone-implant interface. The incorporation of RF coils in the detection device provides a mean to transmit and to receive the detection waves, which makes it possible for such a device to be operated in a wireless setting. This device also includes an energy storage, which serve as a temporary power supply unit to effectively eliminate the need for signal wires and power cores, which in turn further increases the applicability and safety of such a device as a passive, implant able apparatus.

### FIELD OF INVENTION

This invention is related to a micro-implant able apparatus and method for the stability assessment of a two-stage dental implant during Osseo integration processes, whose detection device is based on a transmission of a pulse wave signal from an upper opening of an implant and a subsequent analysis of the reflection waves that measure the changes in mechanical interlock between the bone and the implant resulted from the wound healing processes happened at the gap between bone-implant interface. In other words, this invention is capable of effectively evaluating the dependency between the changes at the bone/dental implant interface and the stability of the dental implant. The incorporation of RF coils in such a device provides a mean to transmit and to receive the detection waves, which makes it possible for such a device to be operated in a wireless setting. This apparatus also includes an energy storage, which serves as a temporary power supply unit to effectively eliminate the need for signal wires and power cores, which in turn further increases the applicability and safety of such a device as a passive, implant able apparatus.

### BACKGROUND OF INVENTION

Dentures are treatments commonly adopted when part of entire chewing function fails as a result of tooth cavities or tooth decay. Conventional treatments for installing dentures include that: (1) grinding the ailing tooth surrounding to allow easy fixture of a tooth bridge; (2) connecting and fixing a framework to teeth next to the ailing tooth surrounding to serve as a mobile denture; and (3) using mucous membrane of the oral cavity as the support for a full denture. Though such diagnostic treatments may take less healing time and less cost, subsequent failure of the treatments turns out to be long-term harassment to the patient, such harassment may include tooth cavities and gum disease cause by inferior bridges, poor appearance of the clasps used in mobile dentures, side effects caused to the anchor tooth, and easy detachment and insufficient biting force of the full denture.

Recently, dental implants have become the optimum solution for resolving the problems caused by dentures. Dental implants are made of titanium metal that is of a highly biocompatible material, but does not disintegrate into bio-toxicity while being installed in human bodies. Therefore, the dental implants, with proper surgical procedures, can guarantee a 90% success rate, provide such advantages as, durability, aesthetics, good biting force, prevents bone loss, and the need for grinding healthy teeth next to the ailing tooth.

Evaluation of stability of a dental implant is, based on the healing processes, categorized into a primary stage and a secondary stage. The factors for determining stability of the dental implant in the primary stage include that: density and thickness of marginal bone, selection of surgical procedures, and configuration and dimensions of the dental implant. The factors for determining stability of the dental implant in the secondary stage, based on the healing conditions of the dental implant in the primary stage, depend on the regeneration and absorbing mechanism at the marginal bone-implant interface.

Recently, in evaluating of the healing conditions of dental implant, a non-destructive technique based on vibration theories has been adopted as a method for the stability assessment, which method uses an impulse force or a sinusoidal wave to trigger dental implant vibration. The mechanical interlock relationships between the harmonic response of an implant and the condition of the bone-implant interface are monitored by means of analyzing the resonance frequency or natural frequency.

Meredith and his coworkers used a steady-state sinusoidal force to induce vibration of dental implants. Their results showed that the resonance frequency was significantly related to the exposed height of the implant the conditions of the supporting structure. However, this method needs to attach a cantilever beam on the test implant for applying the triggering sinusoidal force. Due to limited space in the oral cavity, the clinical application of such a method was limited.

The ROC (Taiwan) Patent Application No. 87110053, entitled “Method of Using Natural Frequency in Evaluating an Implant and Its Surrounding Conditions,” applies a vibration-sensing unit next to the lip surface of the test implant, and uses an impulse force hammer to excite the implant. The vibration signal from the vibration sensing unit and the hammer is received through a scope analyzer to a microprocessor. The relationships between the lowest point of the image mode and the inflection point of the real mode determine the exact natural frequency. However, it is difficult to apply a force to posterior teeth, such as a wisdom tooth, the clinical application of a hammer is also limited.

### SUMMARY OF INVENTION

In view of the above problems, this invention provides a micro-implant able apparatus and for the stability assessment of a dental implant. It is thus a primary object of this invention to adopt micro-electromechanical system (MEMS) to accomplish a micro-implant able apparatus and a method for the stability assessment of a dental implant, which measures the changes in the bone stability resulted from the wound healing processes prior to and subsequent to installation of an implant.

Hence, this invention is related to a micro-implant able apparatus and for the stability assessment of a dental implant, where a device incorporating a substrate and a detection unit is installed on a dental implant. The substrate includes, on a side thereof, an energy storage, RF coils, and a signal processor to allow reception of control signals, analysis of detection waves, and transmission and storage of energy. The substrate includes, on an alternative side thereof, with an acoustic wave actuator and an electroforming, which are joined to the detection components located on a side of the substrate through a vertical connection, to allow generation and reception of detection waves. Processed signals are used to confirm the degree of interlock between the dental implant and the surrounding bone structure of the gum, for determining the appropriate timing of installing dentures over the dental implant.

A preferred embodiment of this invention, in accompaniment with the following drawings, is provided to explain, in details, the features and effects of the method and apparatus of assessment of this invention.

### BRIEF DESCRIPTION OF DRAWINGS

FIG. 1 is a schematic view showing the appearance of this invention;

FIG. 2 includes partial, cross-sectional view of this invention;

FIG. 3 is a partial exploded, perspective view of this invention;

FIG. 4 is a partial, assembled, cross-sectional view of this invention; and

FIG. 5 is a system block diagram illustrating the driving system of this invention.

### DETAILED DESCRIPTIONS OF EMBODIMENTS

This invention is to be assembled to a dental implant installed by means of surgical procedures. An acoustic wave actuator sends detection waves through the dental implant to determine the healing conditions at the bone-implant interface, thereby determining the interlock conditions at the bone-implant interface.

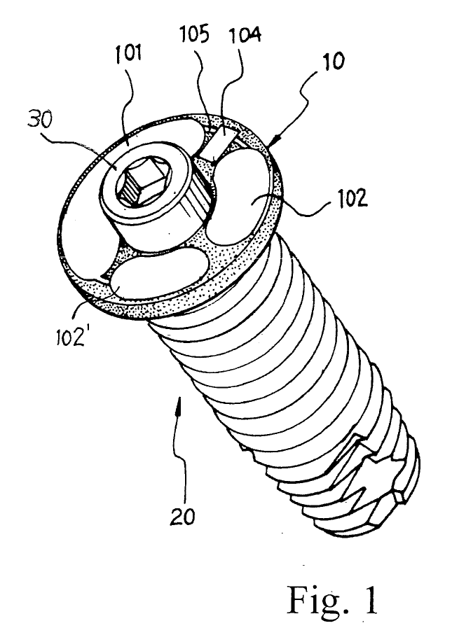

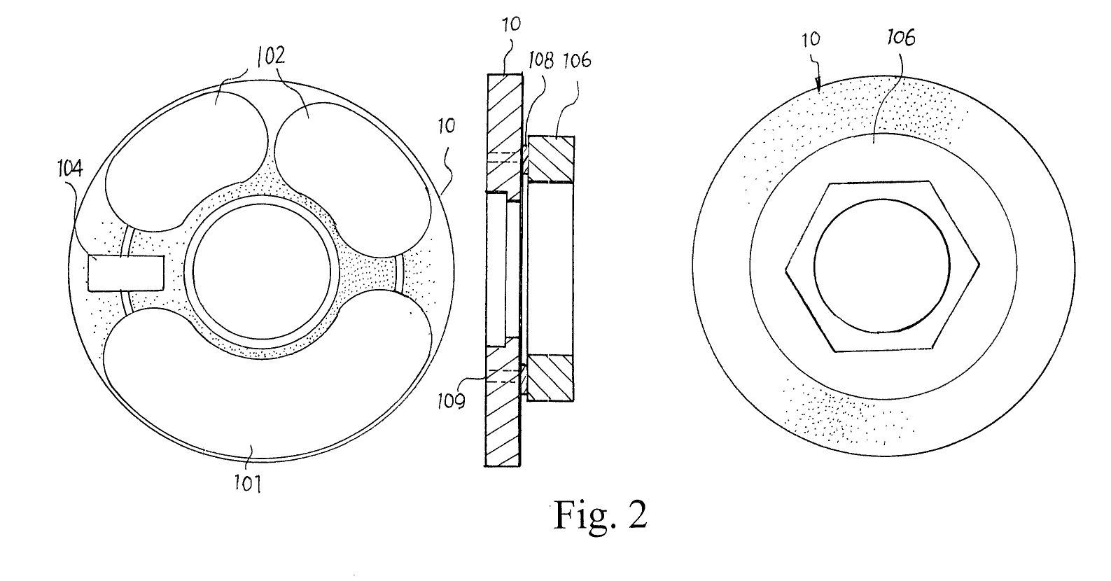

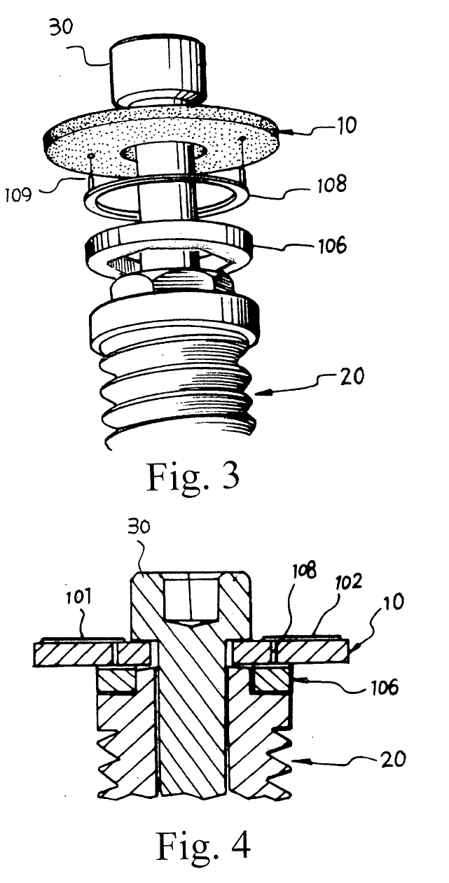

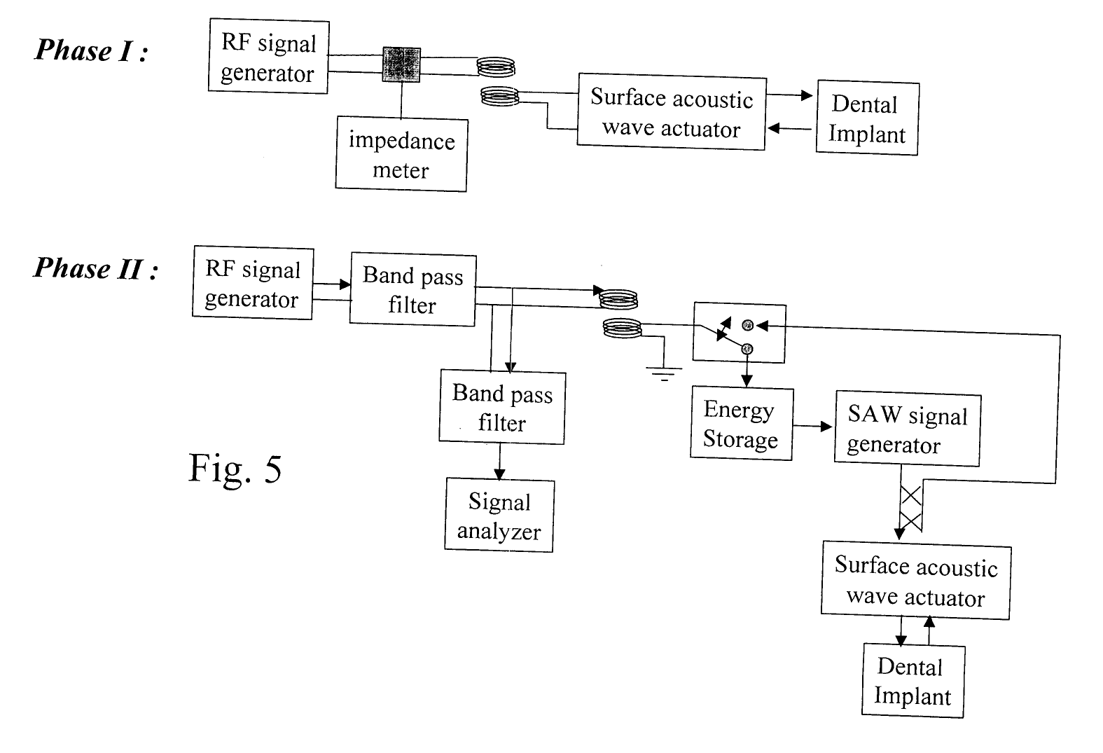

As shown in FIGS. 1, 2 and 3, the apparatus comprises: a micro substrate 10 provided at an upper opening of a dental implant 20 for replacing a healing cap. The substrate 10 includes, on a side thereof, energy storage 101, RF coils 102, 102′, and RF signal generator 103, RFIC 104 that is connected by interconnection lines 105. The substrate 10 includes, on an alterative side thereof, an acoustic wave actuator 108 that is connected to the interconnection lines 105 through a vertical connection 109. Such apparatus is affixed to a dental implant through a bolt 30.

With reference to FIG. 4, the constructions and means for transmitting RF detection waves and driving energy include that:
1. Two RF coils 102 and 102′ serve to transmit and receive driving energy;
2. Two RF coils 102 and 102′ serve to transmit and receive control signals;
3. Two RF coils 102 and 102′ serve to transmit and receive detection signals; and
4. The energy storage 101 serves to store the received driving energy.

As illustrated in FIG. 4, the wireless transmission mechanism of the detection device is accomplished by RF energy. The RF energy is generated by an external device, transmitted through a coil 102, and received by a coil 102′ on the substrate. The received RF energy, based on the operative condition, is converted into two operative modes. First is to apply the RF energy to drive the acoustic wave actuator 108, while the actual driving frequency is dependent on the material and dimensions of the acoustic wave actuator 108. An impedance meter 107 is then adopted to measure changes in the coil impedance for observing change in the system stability. Second is to convert the RF energy into DC energy, which is stored in the energy storage 101 and serves to power an RF signal generator 103 and a signal processor 110.

The constructions and means for the vertical connection 109 and the acoustic wave actuator 108 include that:
1. The acoustic wave actuator 108 is fabricated on one or the other side of the substrate through MEMS fabrication technology, for generating a mechanical detection wave;
2. The vertical connection 109 passes through the substrate 109 for connecting components on both sides;
3. The acoustic wave actuator 108 is powered by the driving energy of the RF coil 102′, which energy is converted into detection waves for measuring changes in the stability subsequent to installation of the dental implant;
4. The acoustic wave actuator 108 receives reflection waves from the bone-implant interface, which waves are then transmitted through the RF coil 102; and
5. The substrate 10, to allow biocompatibility, is formed on the side having the coils with an oxide or a nitride coating, and on the side having the electroforming 106 and acoustic wave actuator 108 with a metallic film.

The acoustic wave actuator 108 may be included at any location of the top of bottom of the substrate 10, and covers the entire opening of oral cavity side of the dental implant 20. The energy-storage located on the top or bottom of the substrate 10 serves to power the acoustic wave actuator 108. The detection waves generated by the acoustic wave actuator 108 may include, but not limited to: acoustic waves surface acoustic waves, and ultrasound. The detection waves pass through the dental implant and are reflected by the bone-implant interface for measuring the wound healing conditions. The reflected signals are received by the acoustic wave actuator 108, and processed by the signal processor located on, or external of the substrate 10, where a software program analyzes the signals. The electroforming 106 on the substrate 10 are fabricated by the MEMS technology. Material for fabricating the acoustic wave actuator 108 or the top and bottom electrodes of the acoustic wave actuator is different from that for fabricating the substrate 10. A biocompatible coating, such as silicon dioxide, silicon nitride, or polymer material, . . . etc, can be applied on the substrate 10 side having the RF coils. Titanium metal film can be applied to the substrate 10 sides having the acoustic wave actuator 108.

1. A micro-implantable apparatus and method for the stability assessment of a two-stage dental implant, for assessing changes in stability after dental implants based on vibration theories, comprising: a detection device that detects a transmission of a pulse wave signal from an upper opening of an implant, and then analyzes reflection waves that measure changes in mechanical interlock at a bone-implant interface resulted from wound healing processes at the bone-implant interface; wherein the detection device includes: at least one RF coil serving as a mean to transmit and to receive the detection waves, and allowing the device to be operated in a wireless setting; an energy storage serving as a temporary power supply unit to effectively eliminate signal wires and power cores; and an acoustic wave actuator for generating mechanical detection waves and for receiving the reflected waves, in which the acoustic wave actuator is powered by RF energy.

2. The apparatus and method of claim 1, wherein one or more RF coils serve to transmit and receive driving energy, to transmit and receive control signals, to transmit and receive detection signals; and to store the received driving energy.

3. The apparatus and method of claim 1, wherein the RF coils powers the acoustic wave actuator is powered by RF energy by at lease two planar RF coils, in which one coil is connected to an external signal source for transmitting the RF energy, and the other coil is connected to the energy storage located on a substrate for receiving the RF energy.

4. The apparatus and method of claim 1, wherein the RF energy is converted into DC energy and stored in the energy storage, in which the DC power powers a signal analyzer and an RFIC.

5. The apparatus and method of claim 3, wherein the acoustic wave actuator is provided on at any location of a top of bottom of the substrate and serves to generate mechanical detection waves.

6. The apparatus and method of claim 3, wherein the system powers the acoustic wave actuator by an RF signal, in which frequency of the RF signal is dependent on the acoustic wave actuator; and wherein the substrate includes an impedance meter to measure changes in the coil impedance for observing change in the dental implant stability.

7. The apparatus and method of claim 3, wherein the detection components on both sides of the substrate are connected by a vertical connection.

8. The apparatus and method of claim 3, wherein the substrate is applied at both sides thereof with a bi-compatible coating.

9. The apparatus and method of claim 8, wherein the substrate is applied at the side having the RF coils with, but not limited to, a silicon oxide coating.

10. The apparatus and method of claim 8, wherein the substrate is applied at the side having the acoustic wave actuator with, but not limited to, a titanium metal coating.

11. The apparatus and method of claim 1, wherein the acoustic wave actuator and the dental implant are provided therebetween with an electroforming for transmitting incident and reflected mechanical detection waves.
